(19) United States
(12) Patent Application Publication
(10) Pub. No.: US 2018/0165742 A1
(43) Pub. Date: Jun. 14, 2018

(54) SELF-LEARNING SYSTEM AND METHOD TO ASSIST DECISION-MAKING INVOLVING MULTIPLE ENTITIES

(71) Applicant: MASTERCARD INTERNATIONAL INCORPORATED, Purchase, NY (US)

(72) Inventor: Vijendra Pratap Singh, Pune (IN)

(21) Appl. No.: 15/378,926

(22) Filed: Dec. 14, 2016

(51) Int. Cl. G06Q 30/06; H04L 29/08; H04L 29/06; G06N 99/00

(52) U.S. Cl. CPC G06Q 30/0631; H04L 67/02; H04W 4/02; H04L 63/0861; G06N 99/005; H04L 63/08

(57) ABSTRACT

A self-learning system, a method, and a non-transitory computer readable medium having computer executable instructions stored thereon, where each assist in decision-making involving any one of a plurality of entities. A user record having items the user previously designated at entities is generated using an online structure. The user is authenticated upon his interaction with the entity, and the user record is evaluated. A distinct result is generated based on the evaluation, and the result is communicated by the online structure to an entity computer. The online structure receives activity data from the entity computer and updates the user record.

### BACKGROUND

The numerous entities in this country that provide various fare do not keep track of the individualized preferences of their many users, and as such, are unable to recommend to a user items that are consistent with the user's preferences. A user may end up selecting an item ill-suited for that user even though the entity carries items that better fit the user's preferences. The situation can become more problematic where the user tries to recall similar fare previously selected at a different entity. Consequently, unless a solution rooted in computer technology is employed, an entity is simply incapable, as a practical matter, of recommending to a user an item he or she selected at a different entity, or a suitable alternative thereof. Similarly, even when users visit an entity they have visited before, they may fail to select fare previously selected and appreciated because they do not recall prior experiences at that entity.

### SUMMARY

The systems and methods disclosed herein may, among other things, allow for the evaluation of received patterns in a self-learning manner so as to enable an entity to provide each user with a distinct result.

In an embodiment, a computer-implemented self-learning method to assist decision-making involving any one of a plurality of entities comprises the step of creating, using an online structure, a user record. The user record includes a first item a user (patron) selected at a first of the plurality of entities and a second item the user selected at a second of the plurality of entities. The identity of the user is authenticated when the user interacts with any of the plurality of entities. The online structure evaluates the user record to determine a recommendation for the user interaction. The recommendation includes a recommended item. The recommendation is transmitted over a network to an entity computer. Activity data transmitted by the entity computer is received at the online structure, and the user record is updated using the activity data.

In another embodiment, a self-learning system to assist decision-making involving any one of a plurality of entities through an online structure comprises a processor and an application programming interface for communicating with an entity computer. The system includes an authenticator for comparing biometric data supplied by a user upon his or her interaction with any one of the plurality of entities with a biometric record. An evaluator evaluates a historical record of the user. The evaluation includes determining whether the user is a repeat customer. A recommendation engine is provided for generating a recommendation for the user based on the evaluation. The recommendation includes a recommended item. A compiler receives activity data from the entity computer to update the historical record.

In yet another embodiment, a non-transitory computer readable medium has computer executable instructions stored thereon. The executable instructions are executed by a digital processor to perform the method of assisting decision-making involving any one of a plurality of entities. The non-transitory computer readable medium includes instructions for generating a user record using an online structure having a recommendation determining processor. The user record includes a first item a user selected at a first of the plurality of entities, and a second item the user selected at one of the first entity and a second of the plurality of entities. The medium has instructions for authenticating an identity of the user when the user interacts with any one of the plurality of entities, and instructions for evaluating the user record to determine a recommendation for the user interaction. The recommendation includes a recommended item. The medium includes instructions for transmitting, over a network, the recommendation to an entity computer, and for receiving at the online structure activity data transmitted by the entity computer. The medium further includes instructions for updating the user record using the activity data.

### BRIEF DESCRIPTION OF THE FIGURES

FIG. 1 shows one example of a self-learning system to assist decision-making involving multiple entities through an online structure, in an embodiment.

FIG. 2 shows an example user record stored in a memory of the online structure.

FIG. 3A shows example personal information in the user record.

FIG. 3B shows example check-in records in the user record.

FIG. 3C shows example fare transaction data in the user record.

FIG. 4 is a flowchart illustrating one example method of using the online structure to generate a customized recommendation for a patron of entities.

FIG. 5 is a flowchart illustrating one example method for authenticating an identity of the patron.

FIG. 6 is a flowchart illustrating another example method for authenticating the identity of the patron.

FIG. 7 is a signaling diagram showing communication between certain components of the system of FIG. 1, in an embodiment.

FIG. 8 shows example inputs for a food and beverage database housed in the memory of the online structure.

FIG. 9 is a flowchart illustrating another example method for generating customized recommendations for the entities' patron.

FIG. 10 is a flowchart illustrating yet another example method for generating customized recommendations for the patron.

### DETAILED DESCRIPTION OF THE EMBODIMENTS

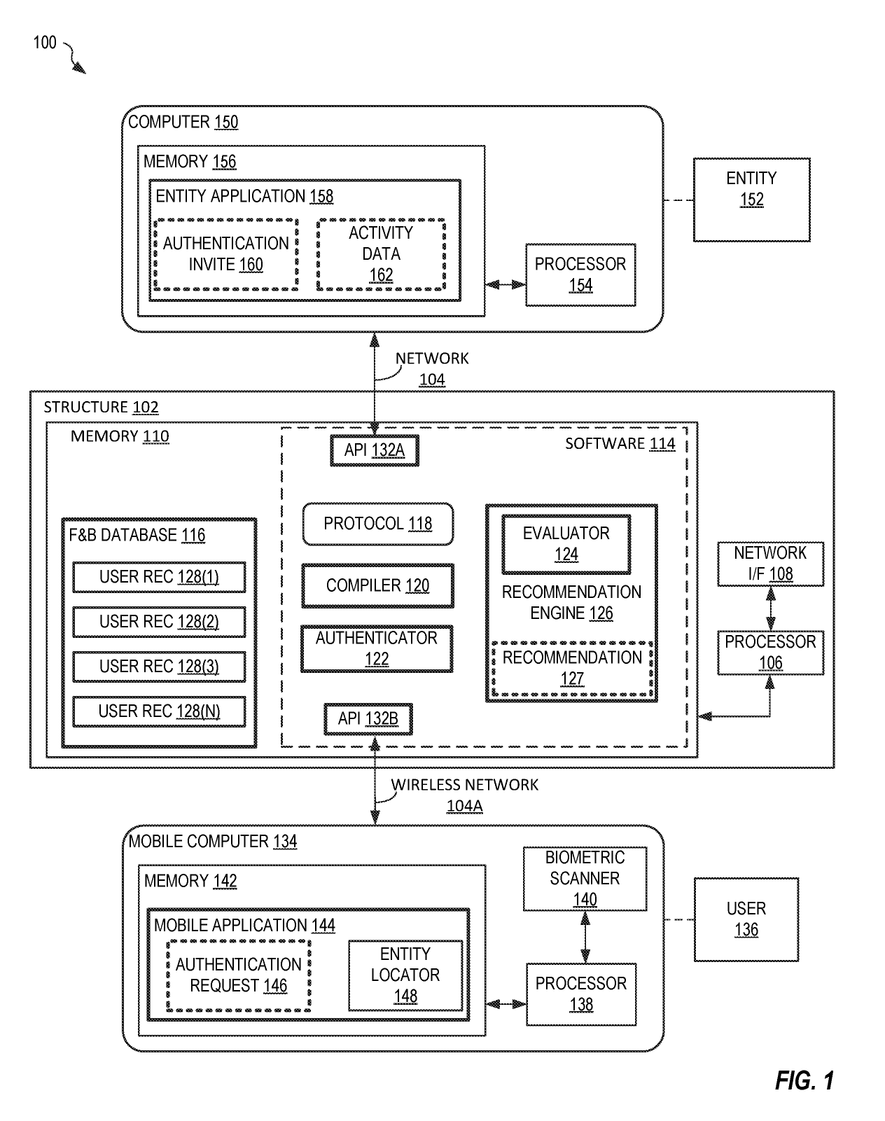

FIG. 1 shows an example self-learning system 100 that assists decision-making involving multiple entities through an online structure 102. Online structure 102 may be implemented by one or more networked computer servers, and is shown with a processor 106 communicatively coupled to a network interface 108 and a memory 110. Processor 106 represents one or more digital processors. Network interface 108 may be implemented as one or both of a wired network interface and a wireless network interface, as is known in the art. Memory 110 represents one or more of volatile memory (e.g., RAM) and non-volatile memory (e.g., ROM, FLASH, magnetic media, optical media, et cetera). Although shown within structure 102, memory 110 may be, at least in part, implemented as network storage that is external to structure 102 and accessed via network interface 108.

Software 114 and food and beverage (i.e., fare) database 116 may be stored within a transitory or non-transitory portion of the memory 110. Software 114 includes machine readable instructions that are executed by processor 106 to perform the functionality of structure 102 as described herein. The food and beverage database 116 may include user records 128 pertaining to a plurality of users (e.g., the food and beverage database 116 may include N user records 128, each pertaining to one of N users).

The online structure 102, using protocol 118 and Application Programming Interface 132A, may communicate over a wired or wireless network 104 with a computer 150 of an entity 152. The term entity, as used herein, refers to one or more of a fine dining, fast food, or other restaurant, a bar, an ice cream shop, a juice shop, a food truck, a grocery store, or any other establishment that serves or otherwise sells food or drink items. The entity computer 150 has a processor 154 and a memory 156. Processor 154 represents one or more digital processors, and memory 156 represents one or more of volatile memory (e.g., RAM) and non-volatile memory (e.g., ROM, FLASH, magnetic media, optical media, and so on). Memory 156 may, in embodiments, be external to the entity computer 150 and be accessed by the computer 150 over a network.

In one embodiment, computer 150 is a mobile computer, such as a laptop, notebook, tablet, smartphone, et cetera, that is used by the entity 152. In another embodiment, computer 150 is a stationary computer, such as a desktop computer situated within the entity 152. The entity 152 is envisioned to download an entity application 158 onto computer 150 that enables computer 150 to communicate with the structure 102 via API 132A. The entity application 158 is software stored in a non-transitory portion of memory 156, and includes machine readable instructions that are executed by processor 154 to improve functionality of computer 150 and to allow communication with structure 102. As discussed herein, in embodiments, entity application 158 provides a graphical user interface that prompts the entity computer 150 to generate an authentication invite 160 and activity data 162.

Network 104, which is formed in part by one or more of the Internet, wireless networks, wired networks, local networks, and so on, facilitates communication between the structure 102 and the entity computer 150. The processor 154 of the entity computer 150, via the entity application 158 and over the network 104, may convey to the structure 102 activity data 162, and receive from the structure 102 a personalized recommendation 127 for a user 136, as discussed below. In embodiments, the entity application 158 may further generate an authentication invite 160 that is communicated to the structure 102 over the network 104.

User 136, who is a patron of the entity 152, may have a mobile computer 134 (e.g., a smart phone, a notebook, a tablet, a laptop, et cetera). The mobile computer 134 includes a processor 138 in communication with memory 142. In an embodiment, the processor 138 is also in communication with a biometric scanner 140. The processor 138 represents one or more digital processors, the memory 142 represents one or more of volatile memory and non-volatile memory, and the biometric scanner 140 represents one or more biometric scanning devices (e.g., a device that scans fingerprints, facial features, handwriting, et cetera) now known or subsequently developed. Mobile application 144, which contains software instructions implemented by the processor 138 to improve the functionality of the computer 134 and to perform the functions thereof as described herein, is stored within a transitory or non-transitory portion of the memory 142. The user 136 downloads the mobile application 144 onto mobile computer 134 to enable mobile computer 134 to communicate with the structure 102 (and/or the entity computer 150). In an embodiment, the mobile application 144 provides a graphical user interface that prompts the user to generate an authentication request 146.

The mobile computer 134 may communicate with the structure 102 over network 104A. The network 104A is preferably (but not necessarily) a wireless network, such as a wireless personal area network, local area network, and so on. As described below, in embodiments, the processor 138 of the mobile computer 134 may communicate to the structure 102 the authentication request 146 over the wireless network 104A. The structure 102 may include an application programming interface (API) 132B to facilitate such communication between it and the mobile computer 134.

The mobile computer 134 may, in embodiments, include an entity locator 148. Entity locator 148 may comprise a location determination device, such as one or more of a global positioning system, a cellular ID locator, a Wi-Fi fingerprinting device, et cetera, which may automatically identify the entity 152 the user 136 is currently visiting (i.e., interacting with). In an embodiment, the entity locator 148 may determine an approximate location of the mobile computer 134 and list on the graphical user interface entities proximate the location, and the user 136 may select the entity he or she is visiting (e.g., entity 152) from that list.

FIG. 1 shows that the structure 102 is in communication with a solitary entity computer 150. Those skilled in the art, however, will appreciate from the disclosure herein that the structure 102 may likewise be configured to communicate with computers of multiple entities that may be unrelated to each other (e.g., with the entity computer of a restaurant that serves Indian cuisine and the entity computer of a food truck that serves burgers). Similarly, while FIG. 1 shows the structure 102 is in communication with one mobile computer 134, the structure 102 may be configured to communicate with mobile computers of multiple unique users.

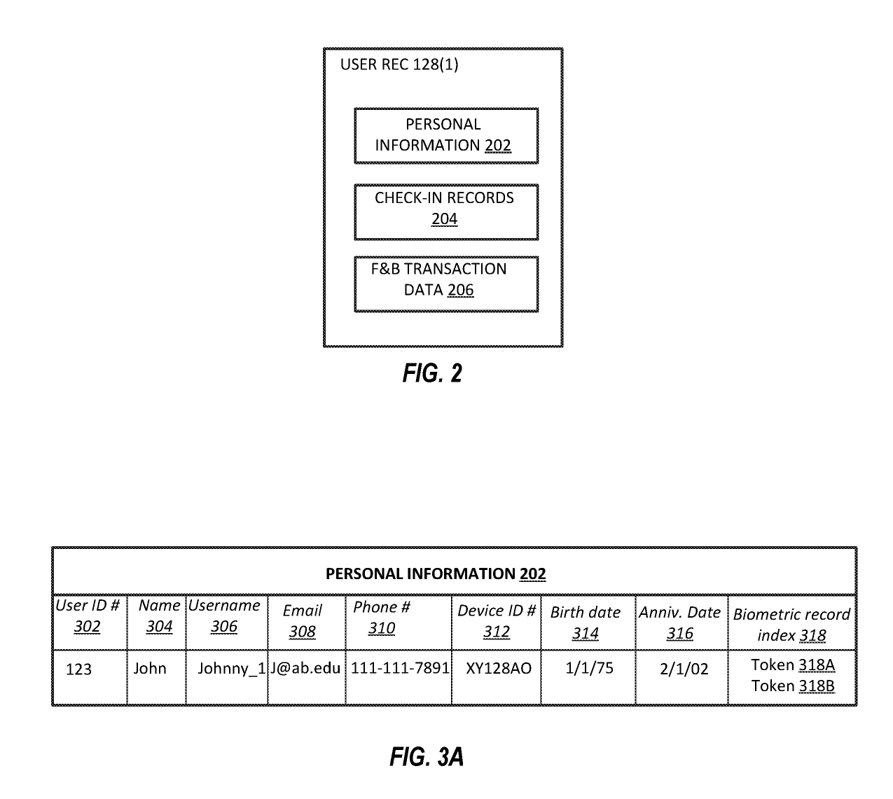

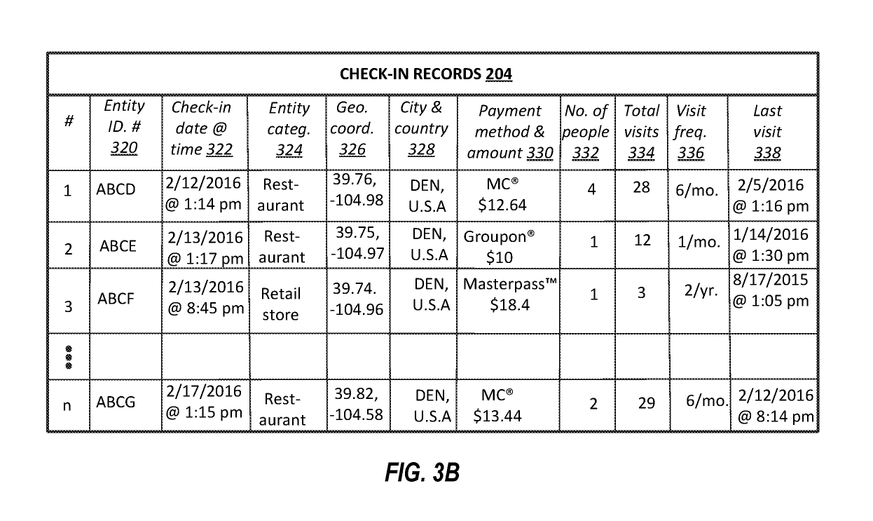

FIG. 2 schematically illustrates an example user record 128(1) stored within the food and beverage database 116 and associated with user 136. User record 128(1) may include personal information 202 of the user 136, and his or her check-in records 204 and food and beverage transaction data 206. FIGS. 3A-3C respectively illustrate the personal information 202, check-in records 204, and food and beverage transaction data 206 in more detail.

Personal information 202 (FIG. 3A) may include one or more of: a user identification number 302, name 304 of the user 136, a username 306, e-mail 308 of the user 136, phone number 310, device identification number 312, birth date 314, anniversary date 316, and a biometric record index 318. The user 136 may supply at least some of the personal information 202 when he or she downloads and installs the mobile application 144 onto mobile computer 134, and this information may thereafter be communicated to structure 102 and stored in a non-transitory portion of memory 110. The device identification number 312 represents a unique number associated with the mobile computer 134 (e.g., an Android ID, a Google Advertising ID, a Universal Device ID, et cetera), and the mobile application 144 may ascertain the device identification number 134 upon install. The biometric record index 318 may comprise one or more tokens, such as a facial recognition token 318A, a fingerprint token 318B, et cetera, which are indexed to the user's biometric record stored at a secure location (e.g., in an encrypted, password protected server). The user 136 may provide biometric information upon installation of the mobile application 144 (e.g., using the biometric scanner 140), and the structure 102 may cause same to be stored at the secure location as a biometric record of the user 136. The user 136 may be allowed to update the personal information 202 as appropriate. For example, if the phone number 310 (or e-mail 308, device identification number 312, anniversary date 316, et cetera) of the user 136 changes, the user 136 may be allowed to update the personal information 202 to reflect this change.

Check-in records 204 (FIG. 3B) may include information regarding visits of the user 136 to various entities. For example, check-in records 204 may include one or more of: an entity identification number 320, a check-in date and time 322, the entity category 324, geographical coordinates 326, city and country 328, payment method and amount 330, number of people 332, total visits 334, visit frequency 336, and last visit 338.

The entity identification number 320 represents a unique number associated with each entity in the system 100. The check-in date and time 322 lists a date and time at which the user 136 visited the entity with which the particular entity identification number 320 is associated. Entity category 324 categorizes the entity as one of a restaurant, food truck, retail store, bar, or other establishment that serves or otherwise sells food and drink items. Geographical coordinates 326 represents the geospatial coordinates of that entity. The payment method and amount 330 represents the method which user 136 used to pay for the food and drink items and related services (e.g., cash, credit card, debit card, gift card, loyalty card, coupon, et cetera), and the amount paid therefor. Number of people 332 represents the number of individuals that accompanied the user 136 to the particular entity at that visit. Total visits 334 represents the number of times the user 136 has checked-in at that entity after installation of the mobile application 144. Visit frequency 336 represents the number of times per year (or per month, per week, et cetera) the user 136 visits the entity on average, and last visit 338 outlines the date and time on which the user 136 last visited that entity.

Food and beverage transaction data 206 (FIG. 3C) may include, among other things, information about the food and drink items the user 136 ordered at the various entities (e.g., the entities detailed in FIG. 3B). For example, food and beverage transaction data 206 may include one or more of: entity identification number 320 (as discussed above for FIG. 3B), industry category 340, channel 342, primary item 344, primary item principal constituents 346, primary item other constituents, secondary item 350, secondary item principal constituents 352, secondary item other constituents 354, beverage 356, cuisine type 358, allergies 360, and special instructions 362.

The industry category 340 represents the type of industry to which the entity the user 136 visited belongs (e.g., beverage industry, food and beverage industry, et cetera). The channel 342 outlines the mode used by the user 136 to order food or drink items at the entity (e.g., entity 152). The primary item 344 represents the main item (e.g., an entrée) ordered by the user 136 at the entity. The primary item principal constituents 346 and primary item other constituents 348 respectively include the main ingredient and secondary ingredients of the primary item 344. For example, where the user 136 ordered shrimp Alfredo as the primary item 344, the protein (shrimp) may constitute the principal constituent 346, and Fettuccine, parmesan, cheese, onions, garlic, et cetera, may constitute the other constituents 348.

The secondary item 350 represents, for example, an appetizer or dessert ordered by the user 136. The secondary item principal constituent 352 and the secondary item other constituents 354 respectively represent the main ingredient and secondary ingredients of the secondary item 350. Those skilled in the art will appreciate that where the user 136 ordered two or more secondary items 350 at a visit to a particular entity (e.g., house salad, chicken wings, and cheesecake), that the principal constituents 352 and other constituents 354 of each may be included in the food and beverage database 206.

The beverage 356 includes a beverage ordered by the user 136 at his or her visit to the respective entity, and the cuisine type 358 represents cuisine type (e.g., Italian, American, Chinese, Thai, et cetera) of the primary item 344. Allergies 360 includes one or more food or drink items or ingredients to which the user 136 is allergic (or to which the user is otherwise averse to). Special instructions 362 represents free text that can be used by an entity (e.g., entity 152) to enter in any special instructions provided by the user 136 with his or her order.

By way of example, the user record 128(1) may indicate that a user 136 named John (FIG. 3A) visited in Denver on Feb. 12, 2016, a restaurant whose entity identification number 320 is ABCD (FIG. 3B), where he ordered shrimp Alfredo as the main course and chicken wings with bleu cheese dip as an appetizer (FIG. 3C). The user record 128(1) may further include additional information about the visit of the user 136 to this entity (e.g., his or her visit frequency 336, last visit 338, principal constituent 346 and other ingredients 348 of the shrimp Alfredo, principal constituent 352 and other ingredients 354 of the chicken wings, et cetera), as discussed above and shown in FIGS. 3A-3C.

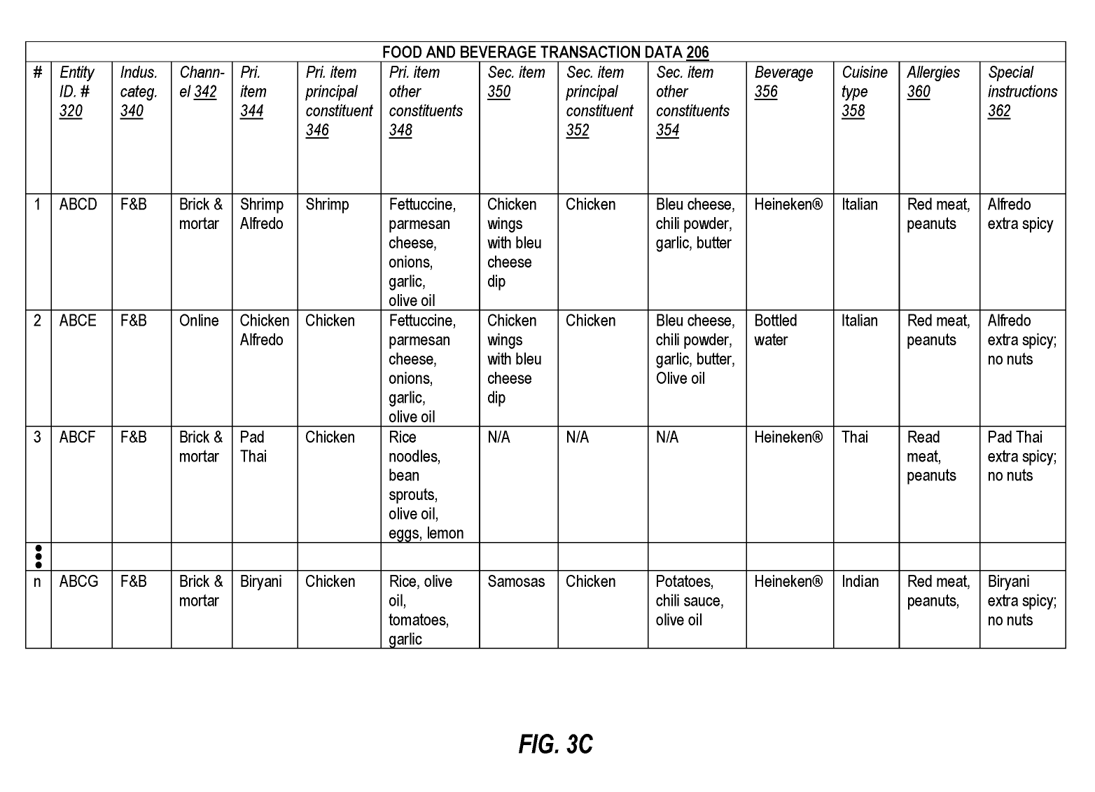

Attention is now directed to FIG. 4, which shows an example method 400 to determine the personalized recommendation 127 for the user (patron) 136. Those skilled in the art will appreciate that the method 400 may likewise be employed by other entities to provide user 136 and other users/patrons a more personalized experience.

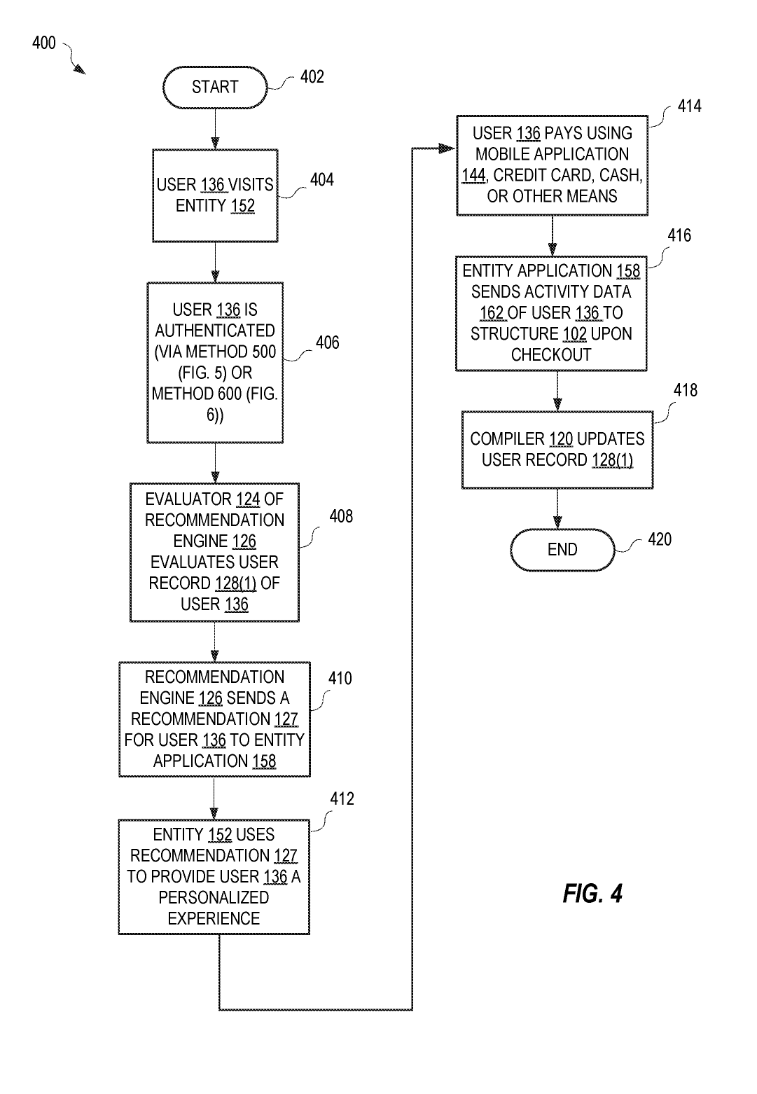

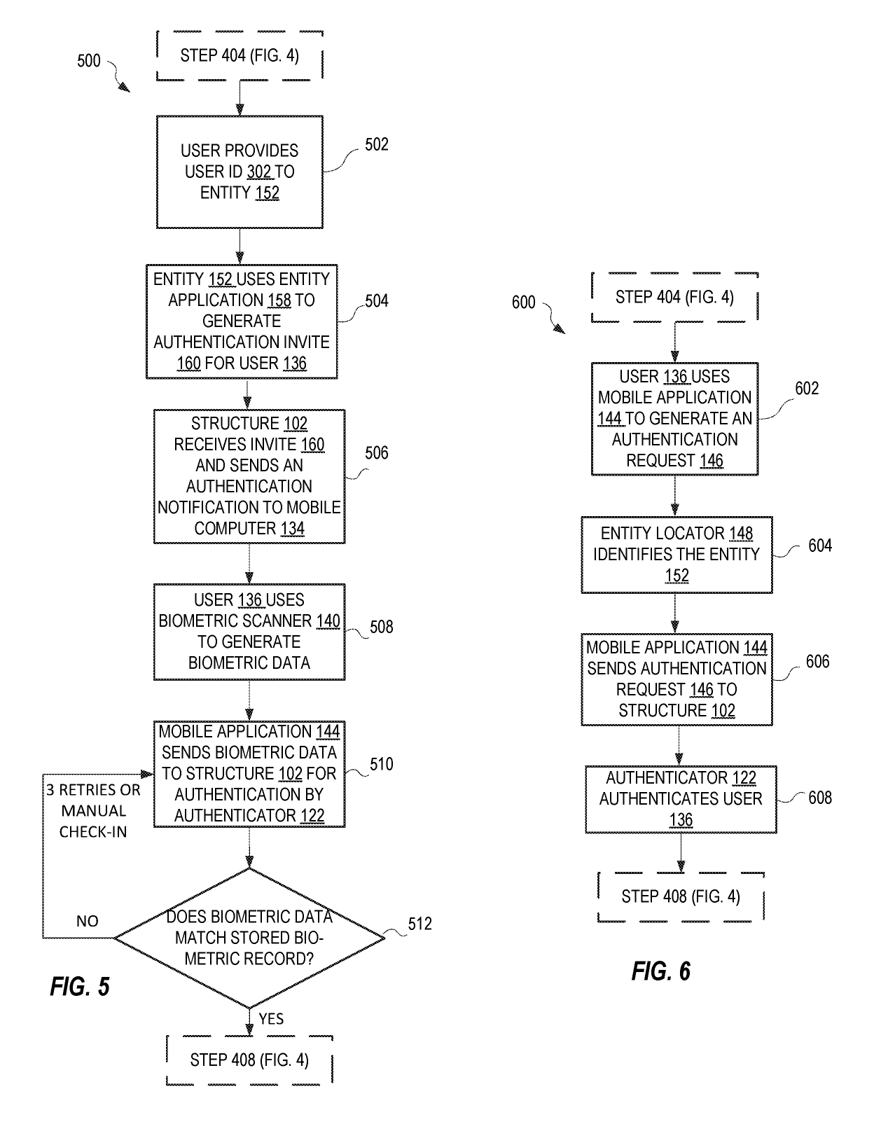

The method 400 may begin at step 402, and at step 404, the user 136 may visit the entity 152. At step 406, the identity of the user 136 may be authenticated. FIGS. 5 and 6 illustrate two example methods of validating the identity of the user 136 upon his or her visit to the entity 152.

FIG. 5 is a flowchart illustrating a method 500 of using the biometric record of the user 136 to authenticate his or her identity. Specifically, after step 404 (FIG. 4), the user 136 may at step 502 provide his or her user identity number 302 (FIG. 3A, or other information unique to the user 136, such as his or her name 304, username 306, et cetera) to the entity 152. At step 504, the entity 152 may use the entity application 158 to generate an authentication invite 160 (FIG. 1) for the user 136. The authentication invite 160 may have embedded therein the user identity number 302, device identification number 312, or other information unique to the user 136.

At step 506, the authentication invite 160 may be communicated by the entity computer 150 over the network 104 to the structure 102. The structure 102, in response to the authentication invite 160, may send to the mobile computer 134 (FIG. 1) of the user 136 an authentication notification prompting the user 136 to enter his or her biometric data. For example, a graphical user interface on the mobile computer 134 may prompt the user (e.g., via a display such as a touch screen) to enter his or her biometric data.

At step 508, the user 136 may use the biometric scanner 140 (FIG. 1) of the mobile computer 134 to input his or her biometric data. For example, the user 136 may use the biometric scanner 140 to scan one or more of his or her fingerprints, thumbprint, voice, iris, et cetera. At step 510, this biometric data collected by the user 136 via his or her mobile computer 134 may be transmitted by the mobile application 144 over the wireless network 104A to the structure 102.

The structure 102 may have an authenticator 122 (FIG. 1). The authenticator 122 may include machine readable instructions executed by the processor 106 to compare the biometric data furnished by the user 136 upon his or her visit to the entity 152 with the biometric record that was created previously (e.g., upon installation of the mobile application 144). For example, the user 136, when visiting the entity 152, may use the biometric scanner 140 to scan his or her fingerprints, and the authenticator 122 may compare this fingerprint scan with the fingerprint scan the user 136 provided when he or she installed the mobile application 144 (or at another time). If the biometric data furnished by the user 136 upon his or her visit to the entity 152 matches his or her biometric record at step 512, the authenticator 122 may validate the identity of the user 136 to check-in the user 136 at the entity 152. If, however, at step 512, the authenticator 122 determines that the biometric data furnished by the user 136 upon his or her visit to the entity 152 does not match his or her biometric record, the user 136 may be allowed to recapture and resubmit his or her biometric data so that authenticator 122 can compare same to the biometric record of the user 136. In an embodiment, the user 136 visiting the entity 152 may be allowed to resubmit his or her biometric data a plurality of times (e.g., up to three times); if the authenticator 122 validates the identity of the user 136, the user 136 may be checked-in to the entity 152. Alternately, if the biometric data furnished by the user 136 upon his or her visit to the entity 152 does not match his or her biometric record, the entity 152 may be prompted to check-in the user 136 manually (e.g., personnel at the entity 152 may verify the e-mail 308 (or other personal information) of the user 136 and then use the graphical interface of the entity application 158 to check-in the user 136 at the entity 152).

As discussed above, the biometric record of the user 136, which may be created when the user 136 downloads and installs the mobile application 144 (or at another time), may be stored at a secure location (e.g., in an encrypted, password protected server (not shown)), and the food and beverage database 116 may contain tokens (e.g., tokens 318A and 318B) that are indexed to the biometric record and can be used to access the biometric record. Such may provide an additional level of security for the stored sensitive personal information of the user 136 (i.e., his or her biometric record) as compared to the information in the food and beverage database 116.

FIG. 6 shows a flowchart illustrating a method 600 for using the user-generated authentication request 146 (FIG. 1) to authenticate and check-in the user 136 at the entity 152. As noted, the user 136 may check-in at the entity 152 using either method 500 or method 600.

When checking-in via method 600, the user 136, after step 404 (FIG. 4), may at step 602 use the mobile application 144 to generate an authentication request 146. For example, the user 136 may use a graphical user interface associated with the mobile application 144 to generate the authentication request 146 and initiate the check-in process. At step 604, the mobile computer 134 may employ the entity locator 148 to automatically identify the entity 152 the user 136 is visiting. Alternately, the mobile computer 134 may use the entity locator 148 to determine an approximate location of the user 136, and list on the graphical user interface all entities proximate (e.g., within 0.25 or 0.5 square miles) of that location; the user 136 may then select the entity 152 he or she is visiting from the list.

Once the entity 152 the user 136 is visiting is identified at step 604, at step 606, the mobile application 144 may communicate over the wireless network 104A the authentication request 146 to the structure 102. In embodiments, the authentication request 146 may have embedded therein the device identification number 312 (FIG. 3A) and/or other information unique to the user 136 (e.g., biometric information supplied by the user 136 upon visiting the entity 152) to enable the structure 102 to identify and authenticate the user 136. At step 608, the authenticator 122 may evaluate the authentication request 146 to verify the identity of the user 136, and the user 136 may thereafter be checked-in to the entity 152.

Returning now to FIG. 4, once the user 136 is checked-in to the entity 152, at step 408, the evaluator 124 (which is a part of the recommendation engine 126) (FIG. 1) may evaluate the record 128(1) of the user 136. The evaluator 124 contains machine readable instructions that are executed by the processor 106, and which examine the user record 128(1) to generate a recommendation 127 for the user 136 that is consistent with the historical records 128(1) of the user 136. As one example, assume that the user 136 visits the entity 152 on Mar. 12, 2016, and that the identification number 320 of this entity 152 is ABCD. The evaluator 124 may evaluate the check-in records 204 (FIG. 3B) to determine that the user 136 visited this entity 152 on Feb. 12, 2016, and may evaluate the food and beverage transaction data 206 (FIG. 3C) to identify the food and drink items previously ordered by the user 136 at this entity 152. In this example, upon evaluation of the user record 128(1) by the evaluator 124, the recommendation engine 126 may generate recommendation 127 that includes chicken wings with bleu cheese dip as the appetizer, extra spicy shrimp Alfredo as the entrée, and a Heineken® as the beverage, because the user record 128(1) indicates that user 136 ordered these food and drink items at his or her prior visit to this entity. The recommendation 127 may also list food and drink items, or ingredients, to which the user is allergic (i.e., allergies 360) and any special instructions 362 that the user 136 may have given on his or her prior visit to the entity 152. Other example methods of evaluating the user record 128(1) to generate personalized recommendation 127 for the user 136 are set forth below.

At step 410, the recommendation engine 126 may over the network 104 communicate the personalized recommendation 127 for the user 136 to the entity computer 150. At step 412, the entity 152 may use the recommendation 127 to provide user 136 a personalized experience. For example, personnel at the entity 152 may recommend an extra spicy shrimp Alfredo to the user 136 and note that the user 136 had ordered this same entrée with the same spice level at his or her previous visit. The entity 152 may further take measures to ensure that no food or drink item containing a substance to which the user 136 is allergic is served to the user 136. Such may obviate the need for the user 136 to reiterate the allergies 360 each time he or she visits an entity.

At step 414, the user 136 may pay for his or her meal using the mobile application 144 (which may comprise, for example, a digital wallet such as Masterpass™ by MasterCard®, Google Wallet™, et cetera), or via cash, credit card, debit card, coupon, or other means. At step 416, upon check-out, the entity application 158 may communicate activity data 162 of the user 136 to the structure 102 over the network 104. This activity data 162 may include, for example, the check-in date and time 322, the payment method and amount 330, the number of people 332 that accompanied the user 136 at this visit to the entity 152, the food and drink items ordered by the user 136 and their respective constituents, any allergies 360 or special instructions 362 communicated by the user 136 to the entity 152, and so forth. At step 418, the compiler 120 of the structure 102 may use the activity data 162 to update the user record 128(1) (e.g., the compiler 120 may update the check-in records 204 and food and beverage transaction data 206 to incorporate information regarding the instant visit). The method 400 may then end at step 420.

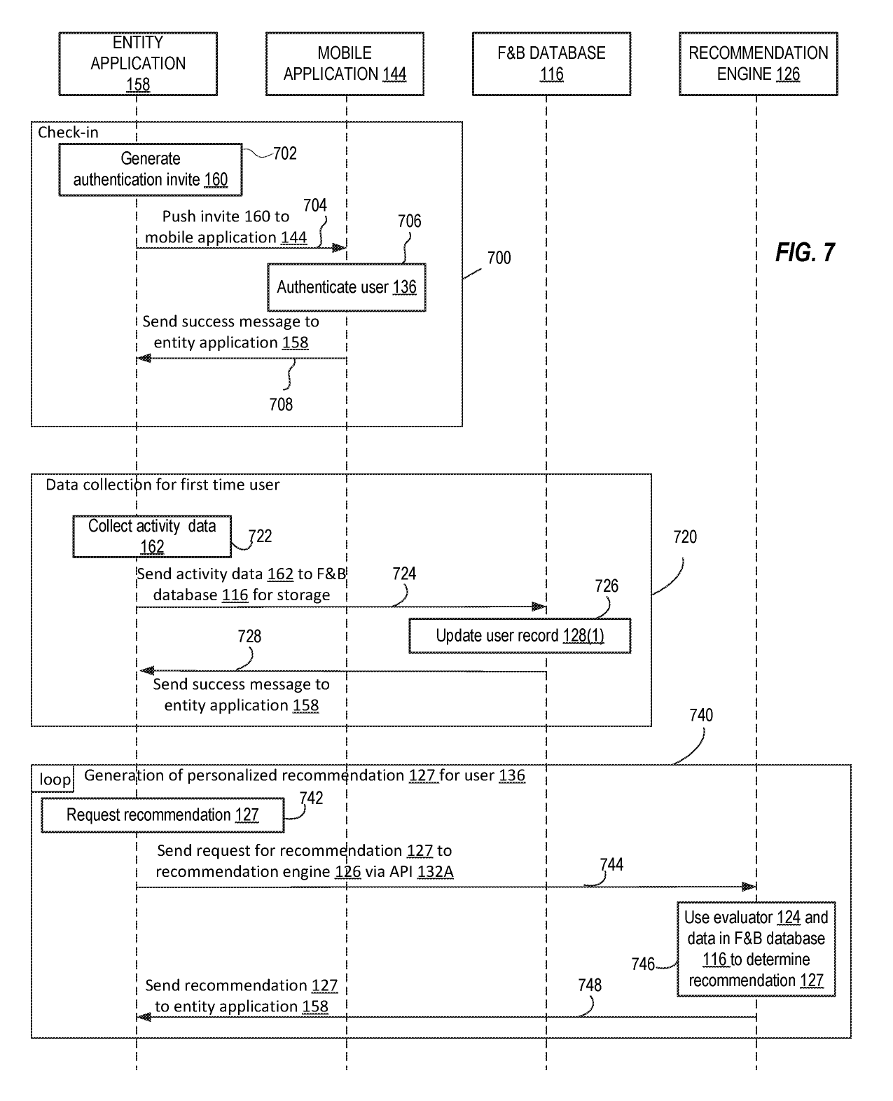

Focus is now directed now to FIG. 7, which shows a signaling diagram illustrating the transfer of data between the entity application 158, mobile application 144, the food and beverage database 116, and the recommendation engine 126, according to an embodiment. The various steps in each of blocks 700, 720, and 740, as described below, occur serially from top to bottom (e.g., in block 700, step 704 occurs after step 702 and before step 706).

Block 700 illustrates an example check-in process. At step 702, the entity application 158 may generate an authentication invite 160, as discussed in more detail above. The authentication invite 160 may then be communicated directly or via the structure 102 to the mobile application 144 at step 704. The user 136 may next be authenticated at step 706, and the mobile application 144 may send a success message confirming the identity of the user 136 to the entity application 158 at step 708.

Block 720 shows an example data collection process for a first-time user of the system 100. At this point, the user record 128(1) may include only the information provided by the user (e.g., user 136) upon installation of the mobile application 144 (i.e., the user record 128(1) may be devoid of check-in records 204 and food and beverage transaction data 206, which are yet to be populated). The user 136 may visit an entity (e.g., entity 152) and check-in as discussed above. The entity application 158 may collect activity data 162 of the user 136 at step 722. For example, the entity application 158 may record the food and drink items ordered by the user 136, any special instructions provided by the user 136, et cetera. At step 724, upon checkout, the entity application 158 may communicate over the network 104 the activity data 162 to structure 102 so the same can be stored in the food and beverage database 116. At step 726, the compiler 120 may update the user record 128(1) (e.g., populate the check-in records 204 and the food and beverage transaction data 206 using the activity data 162). At step 728, a success message may be sent to the entity application 158 confirming that the user record 128(1) has been updated.

Block 740 shows an example process to generate personalized recommendation 127 for user 136. The process 740 may be repeated to generate additional recommendations 127 (e.g., to generate recommendations 127 for visits of the user 136 to other entities). At step 742, upon check-in, the entity application 158 may request a recommendation 127 for the user 136. At step 744, the request may be communicated to the recommendation engine 126. The recommendation engine 126 may at step 746 use the evaluator 124 and data in the food and beverage database 116 (and specifically, in the user record 128(1)) to determine an appropriate recommendation 127 for the user 136. At step 748, the recommendation 127 may be communicated by the recommendation engine 126 to the entity application 158.

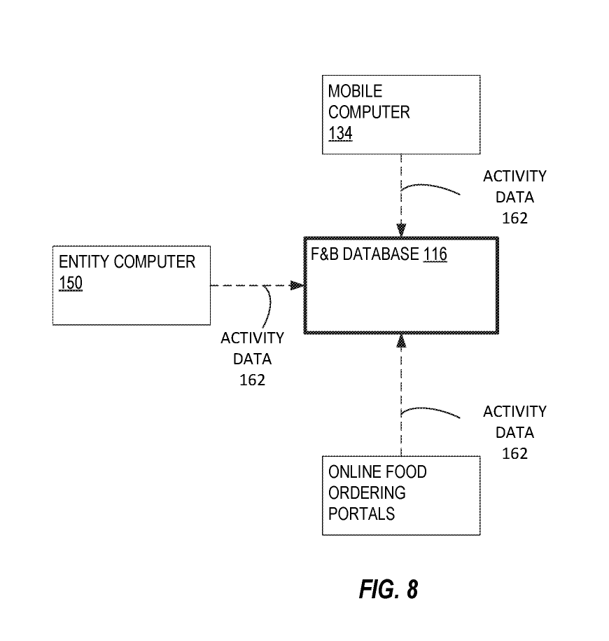

FIG. 8 schematically illustrates communication of the activity data 162 to the food and beverage database 116. The disclosure above teaches that the entity computer 150, via the entity application 158, communicates the activity data 162 to the food and beverage database 116. However, in embodiments, the activity data 162 may also be communicated to the database 116 by the mobile computer 134. For example, the user 136 may use a graphical user interface and the mobile computer 134 to generate the activity data 162 (e.g., use the graphical user interface to list the food and drink items ordered, allergies, special instructions, and so on), and the mobile computer 134 may communicate same to the food and beverage database 116. In some embodiments, activity data 162 may further be communicated to the food and beverage database 116 by online food ordering portals (e.g., Amazon® Prime, Favor™ Delivery, Eat24®, et cetera); for instance, the user 136 may order fare via Amazon® Prime or another online food ordering portal, and the online food ordering portal may then communicate information about the user's order to the food and beverage database 116.

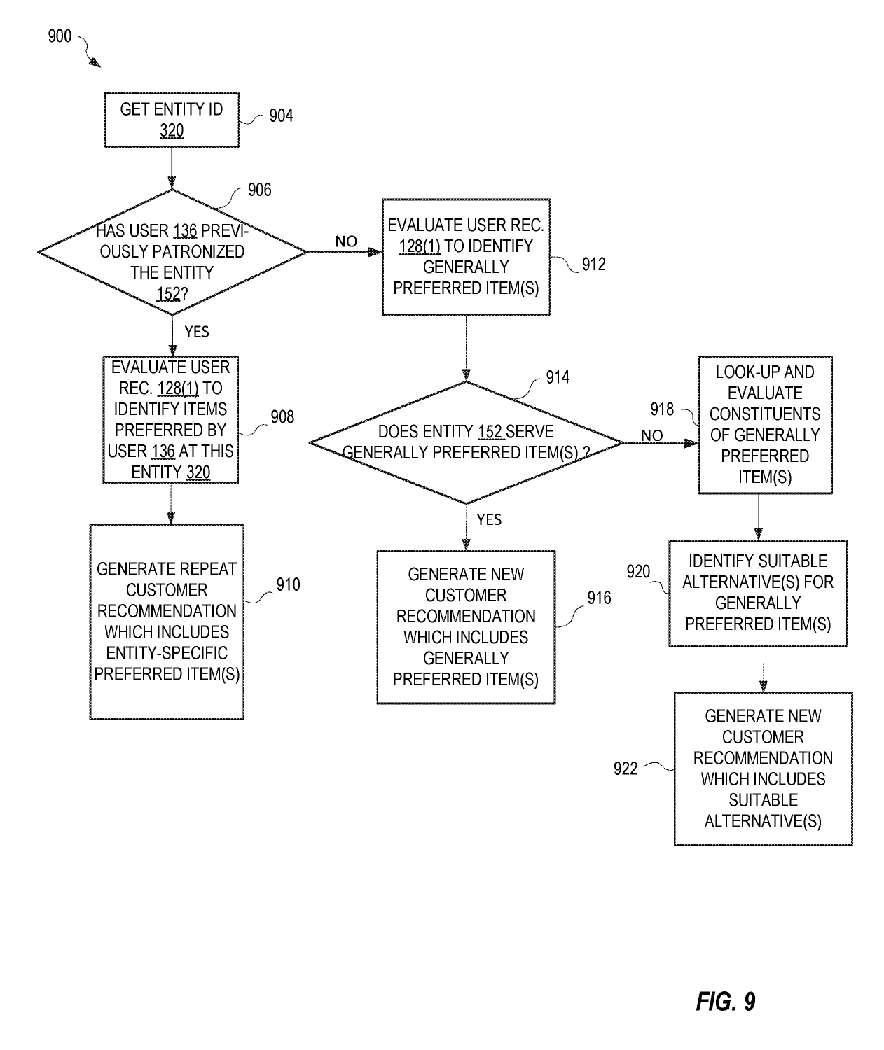

FIG. 9 shows a flowchart illustrating an example method 900 for generating a repeat customer recommendation or a new customer recommendation, depending upon certain circumstances as described for a user 136 below. Referring to FIG. 9, at step 904, upon check-in, the structure 102 may ascertain the identification number 320 of the entity (e.g., entity 152) the user 136 is visiting. At step 906, the evaluator 124 may evaluate the check-in records 204 of the user 136 to determine whether the user 136 has patronized the entity 152 previously. If so, at step 908, the evaluator 124 may evaluate the food and beverage transaction data 206 to identify food and drink items preferred by the user 136 at this entity 152. For example, where the entity ID 320 is ABCF (FIG. 3B), the evaluator 124 may evaluate the food and beverage transaction data 206 and determine that the user 136 ordered extra spicy chicken Pad Thai at his or her previous visit to this entity. The recommendation engine 126, using the evaluator 124, may at step 910 generate a recommendation which includes extra spicy chicken Pad Thai (i.e., a food or drink item the user 136 previously ordered at this entity 152), and communicate same to the entity computer 150. The repeat customer recommendation may also include additional information (e.g., inform the entity that the chicken Pad Thai is to be made without nuts, that the user 136 is allergic to red meat and peanuts, et cetera) collected at one or more prior visits of the user 136 to this entity (or at other entities).

If, however, at step 906 the evaluator 124 determines that the user 136 has not previously patronized the entity he or she is now visiting, the evaluator 124 may at step 912 evaluate the user records 128(1) (specifically, the food and beverage transaction data 206) to identify generally preferred food and drink items for the user 136. Generally preferred food and drink items are those items which the user 136 has previously ordered at another entity or entities. For example, with reference to FIG. 3C, the evaluator 124 may determine that the generally preferred items include shrimp Alfredo, chicken Alfredo, chicken Pad Thai, chicken biryani, chicken wings with bleu cheese dip, Heineken®, et cetera, because the user 136 is known to order these items at other entities. In an example embodiment, the evaluator 124 may consider a food or drink item a generally preferred item only if the user 136 has previously ordered it on multiple occasions. In this embodiment, and with reference to FIG. 3C, chicken wings with bleu cheese dip and Heineken® may be considered by the evaluator 124 to be generally preferred items because the user record 128(1) indicates that the user 136 has ordered same on multiple occasions.

At step 914, the evaluator 124 may determine whether the entity 152 serves one or more generally preferred items. For example, the food and beverage database 116 may include the menu of each entity 152 that is associated with the system 100, and the evaluator 124 may reference the menu of the entity 152 being visited by the user 136 to determine if one or more generally preferred food or drink items are carried by that entity 152. If so, at step 916, the recommendation engine 126 may generate new a customer recommendation which includes the generally preferred item(s), and communicate same to the entity computer 150. In this way, the entity 152 may make a recommendation tailored to the preferences of the user 136 even though the user 136 has not previously visited the entity 152.

If, at step 914, the evaluator 124 determines that the entity 152 does not serve a generally preferred item, at step 918, the evaluator 124 may evaluate the constituents of the food and drink items generally preferred by the user 136. Specifically, the evaluator 124 may determine the generally preferred items (as discussed above) and evaluate their principal constituents. For example, if a generally preferred item is a primary item 344, the evaluator 124 may ascertain and evaluate the primary item's principal constituents 346. Similarly, if the generally preferred item is a secondary item 350, the evaluator 124 may ascertain and evaluate the secondary item's principal constituents 352. Consider, for example, that the evaluator 124 determines that generally preferred items include shrimp Alfredo, chicken Alfredo, chicken Pad Thai, and chicken Biryani (i.e., the primary items 344 identified in FIG. 3C). The evaluator 124 may evaluate the principal constituents 346 of these primary items 344 and determine that the user 136 is fond of chicken, as chicken is the principal constituent of three of these four generally preferred items. At step 920, the evaluator 124 may identify entrees served by the entity 152 that include chicken as a primary constituent. For example, if the entity 152 serves chicken fried rice, the evaluator 124 may identify the chicken fried rice as a suitable alternative for the generally preferred items. In this way, thus, the entity 152 may make a personalized new customer recommendation to the user 136, even though the user 136 has not visited the entity 152 previously, and even where the entity 152 does not serve a food or drink item generally preferred by the user 136.

In an example embodiment, the evaluator 124 may further evaluate the secondary constituents of generally preferred items (e.g., other constituents 348 and 354). For example, the evaluator may determine that entity 152 serves chicken Ravioli, and that Ravioli is a suitable alternative for Fettuccine, which the user 136 has ordered previously. The recommendation engine 126 may thus at step 922 generate a new customer recommendation that includes one or more suitable alternatives for the generally preferred item(s). For example, the new customer recommendation, in this example, may include chicken Ravioli, because such takes into account the fondness of the user 136 for both chicken and pasta.

In some embodiments, the evaluator 124 may ensure that the new customer recommendations, or any of the other recommendations described in the context of FIG. 9, do not include any food or drink item (or substance) to which the user 136 is allergic. For example, if the entity 152 serves beef Fettuccine, the evaluator 124 may filter same out when generating a customer recommendation even though the user record 128(1) indicates that the user 136 favors Fettuccine, because the user record 128(1) also indicates that the user 136 is allergic to red meat. In other embodiments, however, where certain criteria is met, the evaluator 124 may include in the customer recommendation a food or drink item (or substance) to which the user 136 is allergic (e.g., the evaluator 124 may recommend beef Fettuccine because the user record 128(1) indicates the user 136 is fond of Fettuccine, notwithstanding the user allergy to red meat). In these embodiments, a warning may additionally be generated by the recommendation engine 127 warning the entity 152 that the customer recommendation includes an item to which the user 136 is allergic. This way, the user 136 may be given the option to order that item if he or she so chooses (e.g., the user 136 may be warned that the recommended Fettuccine includes red meat, an ingredient to which the user 136 is allergic, but the user 136 may decide to nevertheless order same because his or her allergy to red meat is manageable). It is also envisioned that in some embodiments, the evaluator 124 may generate a warning where the user 136 orders an item to which he or she is allergic on his or her own accord (i.e., where the ordered item to which the user 136 is allergic was not included in the customer recommendation).

The evaluator 124, which in determining a suitable alternative, may take into account ingredients of items as discussed above, and in embodiments, may alternatively (or additionally) take into account other factors. For example, the evaluator 124 may ascertain that the user 136 favors Heineken® beer, and upon determining that the entity 152 the user 136 is currently visiting does not serve same, include in the new customer recommendation another beer that, like Heineken®, is brewed in the Netherlands. Or, for example, the evaluator 124, upon evaluation of the food and beverage transaction data 206, may determine that the user 136 is partial to Italian cuisine, and account for same in generating a suitable alternative for a generally preferred item.

Some entities (e.g., entity 152), to garner customer loyalty, may offer a patron a free food or drink item (e.g., a free appetizer, beer, or dessert, et cetera) to celebrate the patron's birthday, anniversary, or other special occasion. In the prior art, the user 136 typically has to inform personnel at entity 152 that he or she is celebrating a special occasion to receive special treatment. The entity 152 may also ask the user 136 to verify that it is a special occasion (e.g., the entity 152 may ask to check an identification card of the user 136 to confirm that it is his or her birthday), which the user 136 may find off-putting. Where the user 136 does not inform the entity 152 that he or she is celebrating a special occasion, the entity 152 may remain unaware of same, and thereby lose the opportunity to better personalize the experience of the user 136 at the entity 152.

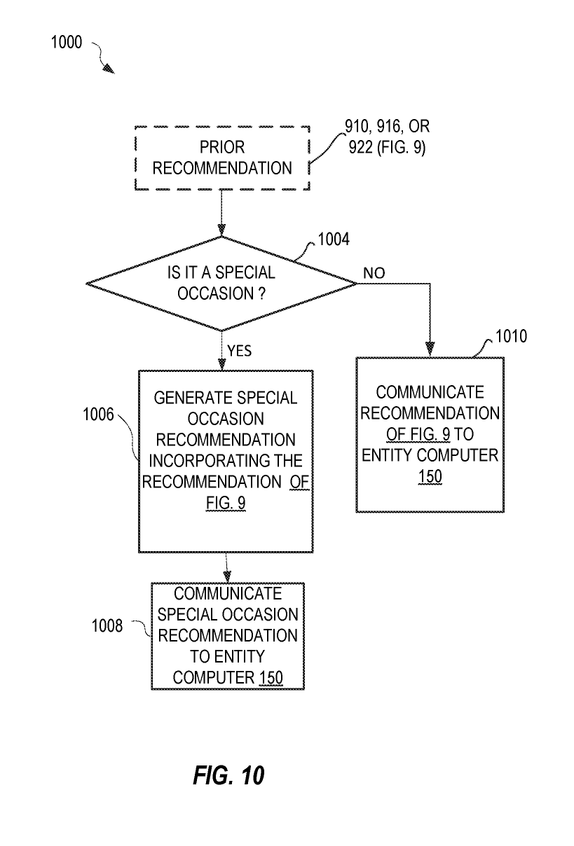

FIG. 10 shows an example method 1000 to generate a special occasion recommendation. At step 1004, after one of the aforementioned recommendations from FIG. 9 have been generated as discussed above, the evaluator 124 may evaluate the user record 128(1) (e.g., the personal information 202 and the check-in records 204) to determine whether it is a special occasion (e.g., a birthday, an anniversary, 50^{th} visit to the entity 152, et cetera). If so, at step 1006, the recommendation engine 126 may generate a special occasion recommendation that incorporates the prior recommendation. For example, the evaluator 124 may analyze the food and beverage transaction data 206 of the user 136 to determine a food or drink item (e.g., an alcoholic beverage, an appetizer, or a dessert) favored by the user 136, and the recommendation engine 126 may, along with one of prior recommendations, recommend that the entity 152 serve this item to the user 136 free of charge. Alternately, or in addition, the recommendation engine 126 may recommend that the user 136 be seated in a preferred section of the entity 152 (e.g., at a table that has the best view), be given a complimentary gift card or coupon, et cetera.

Thus, as has been described, the self-learning systems and associated methods may assist decision-making involving multiple entities through an online structure 102. Changes may be made in the above systems and methods without departing from the scope hereof. For example, in an embodiment, the entity computer 150 (or another computer located at the entity 152) may be employed to effectuate some of the functionality of the mobile device 134; for example, the entity 152 may include a touch screen kiosk (not shown), and the user 136 may check-in (e.g., generate authentication requests, provide biometric records, et cetera) at the entity 152 using the kiosk. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A computer-implemented self-learning method to assist decision-making involving any one of a plurality of entities, comprising:
creating, using an online structure, a user record; the user record including a first item a user selected at a first of said plurality of entities and a second item the user selected at a second of said plurality of entities;
authenticating an identity of the user when the user interacts with any one of said plurality of entities;
evaluating, via the online structure, the user record to determine a recommendation for the user interaction; the recommendation including a recommended item;
transmitting, over a network, the recommendation to an entity computer;
receiving, at the online structure, activity data transmitted by the entity computer; and
updating the user record using the activity data.

2. The method of claim 1 wherein:
the evaluation includes determining whether the user is a repeat patron; and
the recommended item is an item the user selected at a plurality of prior interactions with one or more of said plurality of entities.

3. The method of claim 1 wherein:
the user interaction is with a third entity not previously patronized by the user; and
the evaluation includes determining a suitable alternative for the first item in response to a finding that the third entity carries neither the first item nor the second item.

4. The method of claim 3 wherein determining the suitable alternative includes:
determining a principal constituent of the first item; and
identifying as the suitable alternative an item having the principal constituent.

5. The method of claim 1 wherein:
the user record includes a third item to which the user is allergic; and
the evaluation includes filtering out a food or a beverage that includes the third item.

6. The method of claim 1 wherein the authentication includes:
receiving at the online structure an authentication invite from the entity computer;
generating an authentication notification in response to the authentication invite;
transmitting the authentication notification to a user computer;
receiving from the user computer biometric data of the user; and
comparing the biometric data to a biometric record.

7. The method of claim 1 wherein the authentication comprises receiving at the online structure an authentication request generated by a user computer.

8. The method of claim 1 wherein, based on a determination that the user interaction with the entity is associated with a special occasion, the recommendation includes a free item.

9. The method of claim 8 wherein the free item is an item the user selected at a prior interaction with at least one of said plurality of entities.

10. A self-learning system to assist decision-making involving any one of a plurality of entities through an online structure, comprising:
a processor;
an application programming interface communicating with an entity computer;
an authenticator comparing biometric data supplied by a user upon his interaction with any one of the plurality of entities with a biometric record;
an evaluator evaluating a historical record of the user; the evaluation including determining whether the user is a repeat customer;
a recommendation engine generating a recommendation for the user based on the evaluation; the recommendation including a recommended item; and
a compiler receiving activity data from the entity computer to update the historical record.

11. The self-learning system of claim 10 further comprising a mobile device communicatively coupled to the processor; the mobile device including an entity locator for identifying the entity the user is interacting with.

12. The self-learning system of claim 11 wherein the historical record includes transaction data identifying at least one food item selected by the user and an ingredient thereof.

13. A non-transitory computer readable medium with computer executable instructions stored thereon executed by a digital processor to perform the method of assisting decision-making involving any one of a plurality of entities, comprising:
instructions for generating, using an online structure having a recommendation determining processor, a user record; the user record including a first item a user selected at a first of said plurality of entities, and a second item the user selected at one of the first entity and a second of said plurality of entities;
instructions for authenticating an identity of the user when the user interacts with any one of said plurality of entities;
instructions for evaluating, via the online structure, the user record to determine a recommendation for the user interaction; the recommendation including a recommended item;
instructions for transmitting, over a network, the recommendation to an entity computer;
instructions for receiving, at the online structure, activity data transmitted by the entity computer; and
instructions for updating the user record using the activity data.

14. The computer readable medium of claim 13 further comprising instructions for using a token in the user record to access a corresponding biometric record of the user stored in an external memory.

15. The computer readable medium of claim 13 wherein:
the evaluation includes determining whether the user is a repeat patron; and
the recommended item is an item the user selected at a plurality of prior interactions with one or more of said plurality of entities.

16. The computer readable medium of claim 13 wherein:
the user interaction is with a third entity not previously patronized by the user; and
the instructions for evaluating include instructions for determining a suitable alternative for the first item in response to a finding that the third entity carries neither the first item nor the second item.

17. The computer readable medium of claim 16 wherein the first item and the suitable alternative have a common principal constituent.

18. The computer readable medium of claim 13, further comprising:
instructions for receiving at the online structure an authentication invite from the entity computer;
instructions for generating an authentication notification in response to the authentication invite;
instructions for transmitting the authentication notification to a user computer;
instructions for receiving from the user computer biometric data of the user; and
instructions for comparing the biometric data to a biometric record.

19. The computer readable medium of claim 13 further comprising instructions for receiving at the online structure an authentication request generated by a user computer.

20. The computer readable medium of claim 13 further comprising instructions for including in the recommendation a free item based upon a determination that the user interaction is associated with a special occasion; wherein the free item is an item the user has selected previously at an interaction with at least one of said plurality of entities.
